(19) United States
(12) Patent Application Publication
(10) Pub. No.: US 2008/0319106 A1
(43) Pub. Date: Dec. 25, 2008

(54) Novel Hydrodispersible Waterproofing Agent, the Preparation Thereof, and the Use of the Same in the Field of Construction Especially in Mineral Binding Agent Compositions

(76) Inventors: Jean-Michel Mercier, Gouvieux (FR); Daniel Joubert, Vineuil Saint Firmin (FR); Martial Deruelle, Mornant (FR); Pascal Taquet, Grenay (FR)

Correspondence Address: BUCHANAN, INGERSOLL & ROONEY PC, POST OFFICE BOX 1404, ALEXANDRIA, VA, 22313-1404, US

(21) Appl. No.: 11/597,308

(22) PCT Filed: May 24, 2005
(86) PCT No.: PCT/FR05/01281

§ 371 Date: Dec. 28, 2007

(30) Foreign Application Priority Data
May 27, 2004 (FR) 0405725

(51) Int. Cl. C04B 24/28; C08G 63/60; C08K 3/34

(52) U.S. Cl. 524/5; 524/599; 524/442

(57) ABSTRACT

The invention relates to a novel hydrodispersible waterproofing agent based on at least one water-insoluble and water-immiscible waterproofing agent which has previously been emulsified in a hydrosoluble amphiphilic copolymer composition. The invention also relates to the solid forms of said composition obtained by drying, and to the use thereof in a water-insoluble film-forming polymer composition or in a mineral binding agent composition for applications in the field of construction.

The present invention relates to a novel water-dispersible water repellent based on at least one water-insoluble and water-immiscible water repellent that has previously been emulsified in a water-soluble amphiphilic copolymer composition. The invention also relates to the solid forms obtained by drying this composition. The invention is also of use in a water-insoluble film-forming polymer composition or in an inorganic binder composition for applications in the construction field.

Ever since mankind began constructing artificial dwellings, one problem has been the penetration of moisture into these dwellings. Exposure to elements due to the weather, such as rain and snow, can be reduced to a minimum by suitable building, for example roofs with a satisfactory overhang. However, this does not make it possible to control the absorption of water by the building materials due to their capillary action. This can result in leaching of salts, causing irreversible damage to the cement and thus to the entire composite mortar. To prevent this effect requires that the building structures either be subsequently covered with tar emulsions, asphalt emulsions, wax emulsions or paraffin emulsions, or be impregnated.

Silicones are well known for their water repellent properties. However, silicones, just like fatty acid carboxylates having a divalent counterion or fatty acid carboxylic esters, are water-insoluble, which makes it more difficult to use them for obtaining a good dispersion of the water repellent in aqueous compositions of building materials.

Specifically, these compounds can be introduced into aqueous solutions only in the form of a dispersion or of an emulsion, which requires the addition of an emulsifier or of a protective colloid that harms the desired water-repellency property.

There existed a need to find a means of introducing a water repellent into an inorganic binder composition that does not have the drawbacks described above, i.e. that is easy to implement, in particular for obtaining a good dispersion of the water repellent in the inorganic binder composition, while at the same time maintaining good effectiveness.

This aim and others are achieved by means of the present invention, the subject of which is therefore a novel water-dispersible water repellent based on at least one water-insoluble and water-immiscible water repellent that has previously been emulsified in a water-soluble amphiphilic copolymer composition.

A subject of the invention is also a redispersible powder of the emulsion of water-insoluble and/or water-immiscible water repellent dispersed in the water-soluble amphiphilic copolymer aqueous phase, i.e. a water-dispersible water repellent as defined above, dried in the form of a water-redispersible powder.

A subject of the invention is also a water-insoluble film-forming polymer composition (a latex) comprising at least one water-dispersible water repellent as defined above.

A subject of the invention is also the use of a water-insoluble film-forming polymer composition comprising at least one water-dispersible water repellent as defined above, as an additive for improving the water-repellency properties of an inorganic binder composition.

A subject of the invention is also an inorganic binder composition comprising at least one water-dispersible water repellent.

A subject of the invention is also the use of said inorganic binder composition in mortar or concrete formulations, or the like, based on hydraulic or air-setting binders.

A subject of the invention is therefore, first of all, a novel water-dispersible water repellent based on at least one water-insoluble and water-immiscible water repellent that has previously been emulsified in a water-soluble amphiphilic copolymer composition.

The term “water-dispersible” is intended to mean a compound that readily disperses in a stable and homogeneous manner in an aqueous phase. The homogeneous nature of the dispersed phase thus obtained can be verified by means of laser particle size measurement.

The expression “water-insoluble and water-immiscible water repellent” is intended to mean products capable of protecting porous materials against damage caused by the absorption of water in liquid form.

Among water-insoluble and water-immiscible water repellents, mention may be made of the following compounds:
1) silicones;
2) water repellents other than water-insoluble and water-immiscible silicones.

The term “silicones” is intended to mean polyorganosiloxanes alone or as a mixture; optionally in the presence of functionalized silanes. Among the polyorganosiloxanes that can be used according to the invention, mention may be made of optionally functionalized polyorganosiloxanes containing similar or different units of formula (I):

RₐS_{b}SiO_{(4-a-b)/2} (I)

in which formula:
a and b are equal to 0, 1, 2 or 3;, and a+b =0, 1, 2 or 3;
the symbols R are similar or different and represent a C₁-C₁₈ alkyl group, or a C₆-C₁₂ aryl or aralkyl group optionally substituted with halogen (in particular fluorine) atoms; among the radicals R appearing in formula (I), mention may, for example, be made of methyl, ethyl, isopropyl, tert-butyl, n-hexyl, octyl, trifluoropropyl or phenyl radicals; preferably, at least 50 mol % of said radicals R represent a methyl group;
the symbols X are similar or different and represent a functional radical chosen from those bearing at least one epoxy, carboxyl, hydroxyl, alkoxy, amino, polyether, phosphate, phosphonate, ester, carboxylate, dicarboxyl and/or anhydride unit.

Said polyorganosiloxanes containing the units of formula (I) may be linear polymers that may optionally have up to 50% by weight of branching (units other than “D” units), cyclic polymers or three-dimensional polymers (resins).

As regards resins, this term is intended to define three-dimensional organopolysiloxane oligomers or polymers that are well known and commercially available. They have, in their structure, at least two different units chosen from those of formulae R₃SiO_{0.5} (unit M), R₂SiO (unit D), RSiO_{1.5} (unit T) and SiO₂ (unit Q), at least one of these units being a unit T or Q.

The radicals R are as defined above. It should be understood that, in the resins, some of the radicals R optionally represent functions X.

As examples of resins, mention may be made of MQ resins, MDQ resins, TD resins and MDT resins, it being possible for the reactive functions X to be borne by the M, D and/or T units.

Silicones are known to allow various surfaces or bulk materials to be protected with respect to liquid water, without preventing the passage of water vapor, which is very often an advantage, making it possible in particular to obtain “breathability” properties.

Numerous types of silicones exist that are capable of providing hydrophobic or water-repellency effects and that are known to those skilled in the art.

Mention may in particular be made of the silicones described in patent application FR 03 02921 filed by the Applicant on Mar. 10, 2003. It involves a polyalkylalkylsiloxane comprising at least one hydrocarbon-based graft having between 6 and 18 carbon atoms. The length of the hydrocarbon-based chain of the graft ranges between 6 and 18 carbon atoms. The length of the hydrocarbon-based chain is preferably between 8 and 12 carbon atoms. Even more preferably, the length of the hydrocarbon-based chain is 12 carbon atoms. The hydrocarbon-based chain of the graft may be saturated or unsaturated, and branched or linear. It may also contain halogens, such as fluorine or chlorine, and hydroxyl groups, ether groups, thioether groups, ester groups, amide groups, carboxyl groups, sulfonic acid groups, carboxylic anhydride groups and/or carbonyl groups.

Mention may also be made of the silicone polyethers described in patent application FR 03 11759 filed on Oct. 8, 2003.

These silicone polyethers correspond to formula (I) below:

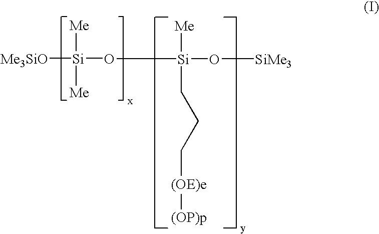

the ethylene oxide or propylene oxide end groups being groups OR, in which:
OE signifies —O—CH₂—CH₂—,
OP signifies —O—CH₂—CH₂—CH₂—,
R represents a hydrogen atom, or a linear or branched alkyl radical having from 1 to 22 carbon atoms, and preferably having from 1 to 4 carbon atoms,
x is a number between 5 and 50,
y is a number between 3 and 10,
e is a number between 10 and 30,
p is a number between 0 and 10,
it being understood that:
x/y is less than 10 and preferably less than or equal to 8,
e+p is less than 30 and preferably less than or equal to 20,
e/p is greater than 1 and preferably greater than or equal to 4, and
x+y is less than 60 and preferably less than 40.

In particular, the silicone polyether is chosen from silicone polyethers of formula (I) corresponding to the following conditions:
x=9.5, y=3.5, e=11.5 and p=2.5, and R represents a hydrogen atom;
x=14, y=4, e=17 and p=1, and R represents H a hydrogen atom;
x=48, y=6, e=15 and p=5, and R represents a hydrogen atom.

According to a preferred mode, the silicone used is fluid.

The term “fluid silicone” is intended to mean silicones that flow freely. In general, these silicones have a viscosity of less than or equal to 500,000 mPa.

Among the water repellents other than water-insoluble and water-immiscible silicones, mention may in particular be made of:
fatty acids, fatty acid carboxylates having a divalent counterion such as calcium stearate or magnesium stearate;
fatty acid esters, such as methyl esters of C₁₀-C₁₆ fatty acids (having from 10 to 16 carbon atoms), erucic acid methyl ester, linoleic acid methyl ester, lauric acid ethylhexyl ester, oleic acid butyl ester, oleic acid ethylhexyl ester, or oleic acid methyl ester;
paraffins of formula CₙH₂ₙ₊₂ with n between 6 and 22 carbon atoms, or CₙH₂ₙ olefins with n between 6 and 22 carbon atoms, that are fluid or liquid at ambient temperature;
waxes of variable chemical nature, such as triglycerides of a fatty acid comprising from 8 to 22 carbon atoms;
or mixtures thereof.

Preferably, at least one silicone is used as a water-insoluble and water-immiscible water repellent.

Even more preferably, at least one fluid silicone is used as a water-soluble and water-immiscible water repellent.

It is also possible to use, as water-insoluble and water-immiscible water repellent, a mixture of at least one silicone (preferably fluid) with at least one water-insoluble and water-immiscible water repellent other than silicones indicated above.

The term “water-soluble amphiphilic copolymer” is intended to mean a polymer consisting of (ethylenically unsaturated) polymerizable monomers that are hydrophobic in nature and of (ethylenically unsaturated) polymerizable monomers that are hydrophilic in nature, in proportion such that the copolymer is water-soluble.

The hydrophilic polymerizable and copolymerizable monomer may be anionic, cationic, amphoteric, zwitterionic or nonionic in nature. It is preferably anionic, and preferably carboxylic or polycarboxylic or also in the form of carboxylic anhydride.

Use is preferably made of a water-soluble amphiphilic copolymer such that the dry extract thereof has a solid and pulverulent form.

Thus, the comonomers, and also the relative proportions thereof, are preferably chosen such that the copolymers obtained have a solid and pulverulent dried form. This can be realized by those skilled in the art through the use of experimental plans.

Among the copolymers having a dry extract in solid and pulverulent form, mention may be made of water-soluble amphiphilic copolymers comprising one or more carboxylic functions.

The water-soluble amphiphilic copolymer comprising one or more carboxylic functions can be chosen, for example, from:
(i) at least one polymer obtained by polymerization
   of at least one ethylenically unsaturated monomer (I) of monocarboxylic or polycarboxylic acid, or else anhydride-type carboxylic acid precursor, type, that is aliphatic, cyclic, linear or branched, and
   of at least one linear or branched, monoethylenically unsaturated hydrocarbon-based monomer (II);
(ii) at least one polymer derived from the polymerization of at least one ethylenically unsaturated, aliphatic, cyclic, linear or branched, monocarboxylic or polycarboxylic acid, or anhydride, monomer (I), and comprising at least one saturated or unsaturated C₄-C₃₀ hydrocarbon-based hydrophobic graft, optionally interrupted with one or more heteroatoms;
(iii) at least one polymer obtained by chemical modification, such as, for example, an esterification, a transesterification or an amidation of a precursor polymer comprising, firstly, sites onto which it is possible to graft a hydrophobic graft, such as, for example, carboxylic acid or ester sites, and comprising, secondly, carboxylic acid or carboxylic acid precursor units.

Preferably, the water-soluble amphiphilic copolymer comprising one or more carboxylic functions is chosen from:
(i) at least one polymer obtained by polymerization
   of at least one ethylenically unsaturated monomer (I) of monocarboxylic or polycarboxylic acid, or else anhydride-type carboxylic acid precursor, type, that is aliphatic, cyclic, linear or branched, and
   of at least one linear or branched, monoethylenically unsaturated hydrocarbon-based monomer (II), this hydrocarbon-based monomer not being aromatic;
(ii) at least one polymer derived from the polymerization of at least one ethylenically unsaturated, aliphatic, cyclic, linear or branched, monocarboxylic or polycarboxylic acid, or anhydride, monomer (I), and comprising at least one saturated or unsaturated C₄-C₃₀ hydrocarbon-based hydrophobic graft, optionally interrupted with one or more heteroatoms, this hydrophobic graft not being aromatic;
(iii) at least one polymer obtained by chemical modification, such as, for example, an esterification, a transesterification or an amidation of a precursor polymer comprising, firstly, sites onto which it is possible to graft a hydrophobic graft, such as, for example, carboxylic acid or ester sites, this hydrophobic graft not being aromatic, and comprising, secondly, carboxylic acid or carboxylic acid precursor units.

The emulsification of the water-insoluble and water-immiscible water repellent in the water-soluble amphiphilic copolymer is carried out by simple addition of the water-insoluble and water-immiscible water repellent to a concentrated aqueous solution of water-soluble amphiphilic copolymer.

The term “concentrated solution” is intended to mean a solution comprising at least 10% by weight of water-soluble amphiphilic copolymer in water, and preferably at least 25% of this copolymer.

The proportions of the water-insoluble and/or water-immiscible water repellent and of the water-soluble amphiphilic copolymer in the emulsion can be between:
70% and 30% by dry weight of the water-insoluble and/or water-immiscible water repellent relative to the total weight of the dry mixture;
30% and 70% by dry weight of the water-soluble amphiphilic copolymer relative to the total weight of the dry mixture.

It is important to note that it is not necessary to add a conventional emulsifier in order to obtain an emulsion.

The water-soluble amphiphilic copolymers mentioned above have the advantage of having emulsifying properties that are sufficient to obtain, without the addition of a further emulsifier, the emulsification of a water-insoluble and/or water-immiscible water repellent, in particular when it is a fluid silicone-based water repellent.

In addition, the concentrated solutions of water-soluble amphiphilic copolymer comprising carboxylic functions, mentioned above, have the advantage of having a viscosity that is sensitive to pH.

Alkaline solutions are very fluid. Their viscosities increase when the pH decreases.

This property is very advantageous since it thus makes it possible, very simply, to regulate the viscosity of this solution of water-soluble amphiphilic copolymer that corresponds to the aqueous phase of the emulsion. Now, this regulation of viscosity, combined with suitable stirring conditions and the regulation of temperature and of the metering of dry extract, makes it possible to regulate the particle size of the emulsion, i.e. the size of the droplets of water-insoluble or water-immiscible water repellent in the aqueous solution of water-soluble amphiphilic copolymer.

In terms of emulsifying technology, the notion of making the viscosities and the rheological behaviors of the continuous phase and of the dispersed phase as close as possible is well known to those skilled in the art. In fact, the stresses and the mechanical shear necessary for emulsification are transmitted better to the interfaces if the viscosity differential between the two phases is low. These methods of preparation are, for example, described in Encyclopedia of Emulsions Technology by Paul Becher, published by Marcel Dekker Inc, 1983.

The preferred water-soluble amphiphilic copolymers comprising one or more carboxylic functions of the invention also have the advantage, when they are dried, of producing a solid product in the form of a non-tacky powder.

Thus, when the emulsion of water-insoluble and/or water-immiscible water repellent dispersed in the aqueous phase of water-soluble amphiphilic copolymer comprising one or more carboxylic functions is dried, a non-tacky and water-redispersible powder is obtained.

The term “water-redispersible powder” is intended to mean a powder which, when it is brought together with water, makes it possible to regenerate an emulsion of water-insoluble and/or water-immiscible water repellent, the droplet size of which is of the same order of magnitude as the initial emulsion before drying.

A subject of the invention is also a redispersible powder of the emulsion of water-insoluble and/or water-immiscible water repellent dispersed in the water-soluble amphiphilic copolymer aqueous phase, i.e. a water-dispersible water repellent as defined above, dried in the form of a water-redispersible powder.

This formulating of a water-soluble water repellent as defined above, dried in the form of a water-redispersible powder, has many advantages. It can be easily stored.

In addition, this formulating makes it possible to incorporate this water repellent powder into ready-to-use dry mortar formulations.

Finally, this formulating makes it possible to obtain a very good dispersion of this water repellent powder in the mass of inorganic binder that it is desired to make water-repellent, and therefore to obtain effective water-repellency throughout the mass of the consolidated material after the addition of mixing water, and in particular over all the surfaces of the consolidated material.

A subject of the invention is also a water-insoluble film-forming polymer composition (a latex) comprising at least one water-dispersible water repellent as defined above.

This composition may be in the form of an aqueous dispersion of water-insoluble film-forming polymer (latex) or in the form of a redispersible latex powder. The term “redispersible latex powder” is intended to mean a water-redispersible latex powder. The redispersible latex powders are known to those skilled in the art.

The method of preparing this composition consists in mixing a water-dispersible water repellent as defined above with a water-insoluble film-forming polymer (latex).

This mixture of the water-dispersible water repellent and the latex can be prepared in the form of a mixture of redispersible water-soluble water repellent powder with a redispersible latex powder composition.

It is also possible to introduce the water-dispersible water repellent into the latex during the polymerization, or preferably post-polymerization. The latex added to can thus be obtained in the form of an aqueous dispersion.

It is also possible to dry the aqueous dispersion thus obtained, so as to obtain a redispersible latex powder to which water-dispersible water repellent has been added. This then involves co-spraying.

It is also possible to add the water-dispersible water repellent in powdered form to the latex spray tower, i.e. at the time the latex is dried.

Among all these possible forms of mixtures, the preferred case is that where the water-dispersible water repellent in the form of a redispersible powder is introduced into a latex powder that is also redispersible, or when the water-soluble water repellent in powdered form is added to the latex spray tower, i.e. when the latex is dried.

Specifically, a latex powder to which water repellent has been added in the form of a redispersible powder will thus be obtained. This has many advantages.

It can be easily stored.

In addition, this formulating makes it possible to use this latex powder to which water repellent has been added in ready-to-use dry mortar formulations.

Finally, this formulating makes it possible to obtain a very good dispersion of this latex powder to which water repellent has been added, in the mass of inorganic binder during the water-mixing phase, and therefore to obtain effective water-repellency throughout the mass of the consolidated material after addition of the mixing water, and in particular over all the surfaces of the consolidated material.

The amount of water-soluble water repellent added to the water-insoluble film-forming polymer must be sufficient to give good water-repellency properties to the water-insoluble film-forming polymer composition and/or to the inorganic binder composition for which it is desired to improve the water-repellency properties.

The amount of water-dispersible water repellent added to the water-insoluble film-forming polymer is such that:
the amount of water-dispersible water repellent is between 10% and 90% by weight of dry water-dispersible water repllent relative to the total weight of the dry mixture,
the amount of the aqueous dispersion of water-insoluble film-forming polymer (latex) is between 90% and 10% by weight of dry latex relative to the total weight of the dry mixture.

Preferably, the amount of water-dispersible water repellent added to the water-insoluble film-forming polymer is such that:
the amount of water-dispersible water repellent is between 40% and 60% by weight of dry water-dispersible water repellent relative to the total weight of the dry mixture,
the amount of the aqueous dispersion of water-insoluble film-forming polymer (latex) is between 60% and 40% by weight of dry latex relative to the total weight of the dry mixture.

Suitable water-insoluble polymers are homopolymers or copolymers that are in the form of an aqueous dispersion or that can be converted into an aqueous dispersion, and subsequently can be formulated into a powder by spray-drying.

The average particle size of the powder is preferably from 10 to 1000 μm, more preferably from 20 to 700 μm and particularly from 50 to 500 μm.

The preferred water-insoluble polymers are obtained by polymerization of monomers chosen from:
vinyl esters, and more particularly vinyl acetate;
alkyl acrylates and alkyl methacrylates in which the alkyl group contains from 1 to 10 carbon atoms, for example methyl, ethyl, n-butyl or 2-ethylhexyl acrylates and methyl, ethyl, n-butyl or 2-ethylhexyl methacrylates;
vinylaromatic monomers, in particular styrene.

These monomers can be copolymerized with one another or with other ethylenically unsaturated monomers, so as to form homopolymers, copolymers or terpolymers.

By way of nonlimiting examples of monomers that can be copolymerized with vinyl acetate and/or acrylic esters and/or styrene, mention may be made of ethylene and olefins such as isobutene or alpha-olefins having from 6 to 20 carbon atoms, and preferably from 8 to 14 carbon atoms; vinyl esters of saturated monocarboxylic acids, which may or may not be branched, having from 1 to 16 carbon atoms, such as vinyl propionate, vinvl “Versatate” (registered trademark for C₉-C₁₁ branched acid esters), and in particular vinyl neodecanoate known as Veova 10, vinyl pivalate, vinyl butyrate, vinyl 2-ethylhexyl hexanoate, or vinyl laurate; esters of monocarboxylic or dicarboxylic unsaturated acids having 3 to 6 carbon atoms with alkanols having 1 to 10 carbon atoms, such as methyl, ethyl, butyl or ethylhexyl maleates or methyl, ethyl, butyl or ethylhexyl fumarates; vinylaromatic monomers such as methylstyrenes, vinyltoluenes; vinyl halides such as vinyl chloride, vinylidene chloride, diolefins, particularly butadiene; (meth)allyl esters of (meth)-acrylic acid, (meth)allyl esters of monoesters and diesters of maleic acid, fumaric acid, crotonic acid and itaconic acid, and also alkane derivatives of acrylic and methacrylic acid amides, such as N-methallylmaleimide.

At least two copolymerizable monomers of different natures can in particular be chosen so as to obtain a terpolymer.

By way of example, mention may be made of a terpolymer of the type vinyl acetate/vinyl versatate/dibutyl maleate.

It is also possible to add, to the monomers copolymerizable with vinyl acetate and/or acrylic esters and/or styrene, at least one other monomer chosen from the following list:
acrylamide, ethylenically unsaturated carboxylic or dicarboxylic acids, preferably acrylic acid, methacrylic acid or crotonic acid, ethylenically unsaturated sulfonic acids and salts thereof, preferably vinylsulfonic acid or 2-acrylamido-2-methylpropanesulfonic acid (AMPS), or sodium methallylsulfonate;
crosslinking monomers bearing at least two ethylenic unsaturations, such as diallyl phthalate, diallyl maleate, allyl methacrylate, triallyl cyanurate, divinyl adipate or ethylene glycol dimethacrylate;
monomers with silane functions, such as vinyltrimethoxysilane or vinyltriethoxysilane.

These monomers are added in an amount of between 0.05% and 10% by weight, relative to the total weight of the monomers. These monomers are added during the polymerization.

Generally, the polymerization of the monomers is carried out in an emulsion polymerization process in the presence of an emulsifier and/or of a protective colloid, and of a polymerization initiator.

The monomers used may be introduced as a mixture or separately and simultaneously into the reaction medium, either before the beginning of the polymerization in one go, or during the polymerization in successive or continuous fractions.

The emulsifiers that can be used for the emulsion polymerization or copolymerization of the water-insoluble polymers (latex) are anionic, cationic or nonionic emulsifiers.

They are generally used in a proportion of from 0.01% to 5% by weight relative to the total weight of the monomers.

Emulsifiers that are generally used are the conventional anionic agents represented in particular by alkyl sulfates, alkyl sulfonates, alkylaryl sulfates, alkylaryl sulfonates, aryl sulfates, aryl sulfonates, sulfosuccinates, alkali metal alkylphosphates, or abietic acid salts, that may or may not be hydrogenated.

The emulsion polymerization initiator is represented more particularly by hydroperoxides such as aqueous hydrogen peroxide, cumene hydroperoxide, diisopropylbenzene hydroperoxide, paramenthane hydroperoxide or tert-butyl hydroperoxide, and by persulfates such as sodium persulfate, potassium persulfate or ammonium persulfate. It is used in an amount of between 0.05% and 3% by weight relative to the total weight of monomers. These initiators are optionally combined with a reducing agent, such as sodium bisulfite, sodium hydrogen sulfite, sodium thiosulfate, sodium formaldehyde sulfoxylate, polyethyleneamines, sugars (dextrose, sucrose), ascorbic acid or isoascorbic acid, or metal salts. The amount of reducing agent used ranges from 0% to 3% by weight relative to the total weight of monomers.

The reaction temperature, which depends on the initiator used, is generally between 0 and 100° C., and preferably between 30 and 90° C.

A transfer agent may be used in proportions ranging from 0% to 3% by weight relative to the monomer(s), generally chosen from mercaptans such as N-dodecylmercaptan, tert-dodecylmercaptan or 2-mercaptoethanol, allyl derivatives such as allyl alcohols, cyclohexene, and halogenated hydrocarbons such as chloroform, bromoform or carbon tetrachloride. It makes it possible to regulate the length of the molecular chains. It is added to the reaction medium either before polymerization, or during polymerization.

Protective colloids can also be used at the beginning of, during or after the polymerization.

Suitable protective colloids are polyvinyl alcohols and derivatives thereof, for example vinyl alcohol/vinyl acetate copolymers, modified polyvinyl alcohols comprising reactive functions, such as silanols, mercaptans, amines or formamides, and comprising hydrophobic comonomers such as ethylene, vinyl versatate, vinyl 2-ethylhexyl hexanoate, polyvinylpyrrolidones (PVPs), polysaccharides, for example starches (amylose and amylopectin), cellulose, cellulose ethers, for instance hydroxyethylcellulose, guar, tragacanthic acid, dextran, alginates and carboxymethyl, methyl, hydroxyethyl or hydroxypropyl derivatives thereof, proteins, for example casein, soybean proteins, gelatins, synthetic polymers, for example poly(meth)acrylic acid, poly(meth)acrylamide, polyvinylsulfonic acids, and water-soluble copolymers thereof, melamine-formaldehyde sulfonates, naphthalene-formaldehyde-sulfonates, styrene/maleic acid copolymers, and vinyl ether/maleic acid copolymers. Polyvinyl alcohol is particularly preferred as protective colloid for the polymerization. A particular protective colloid used is a polyvinyl alcohol having a degree of polymerization of 200 to 3500 and having a degree of hydrolysis of 80 to 99 mol %, and preferably of 86% to 92%.

The protective colloids are added in proportions of between 0.5% and 15% by weight relative to the total weight of monomers, and preferably between 2% and 10% by weight relative to the total weight of monomers.

In a particularly preferred embodiment, the latex composition to which water-dispersible water repellent has been added in redispersible powder form comprises 0% to 35% by weight, preferably 3% to 15% by weight, of protective colloid relative to the total weight of the water-insoluble polymer.

The suitable protective colloids are the same as those mentioned above.

In cases where the latex is dried so as to produce a water-redispersible powder thereof, the preferred anti-caking agents are aluminum silicates, calcium carbonates or magnesium carbonates, or mixtures thereof, silicas, alumina hydrate, bentonite, talc, or mixtures of dolomite and talc, or of calcite and talc, kaolin, barium sulfate, titanium oxide or calcium sulfoaluminate (satin white).

The particle size of the anti-caking agents is preferably in the range of from 0.001 to 0.5 mm.

The water-insoluble film-forming polymer composition comprising a water-dispersible water repellent can also comprise another powdered water repellent, chosen in particular from fatty acids in free acid form or in the form of alkali metal salts thereof, such as lauric acid, stearic acid, alkali metal laurates or alkali metal stearates.

This water-insoluble film-forming polymer composition comprising a water-dispersible water repellent has the advantage that it can be used as it is or in combination with other components as additive for improving the water-repellency properties of an inorganic binder composition.

Thus, a subject of the invention is also the use of the water-insoluble film-forming polymer composition comprising a water-dispersible water repellent, as additive for improving the water-repellency properties of an inorganic binder composition.

A subject of the invention is also an inorganic binder composition comprising a water-dispersible water repellent.

The inorganic binders may be air-setting binders or hydraulic binders.

The term “air-setting binder” is intended to mean, for example, binders based on lime or from plasters.

The hydraulic inorganic binders can be chosen from cements that may be of Portland, high-alumina or blast-furnace type, or mixtures of these hydraulic binders. Other compounds often added as additives to cement also have hydraulic properties, such as fly ash or calcined shales. Mention may also be made of pozzolans that react with lime and form calcium silicates.

The inorganic binders are manufactured from natural materials that are treated at very high temperature so as to remove the water and convert the materials to inorganic compounds capable of reacting with water or with carbon dioxide (CO₂) so as to produce a binder that, after drying, forms a compact mass having good mechanical properties.

The inorganic binders may be in the form of grouts, mortars or concretes, i.e. fine or coarser granulated material, such as sand or stones, are added, generally during mixing with water.

The water-soluble water repellent can be added directly to the inorganic binder composition in an amount of between 0.05% and 10% by weight of dry water-soluble water repellent relative to the total weight of the dry inorganic binder composition.

Preferably, this amount is between 0.1% and 5% by weight of the dry water-dispersible water repellent relative to the total weight of the dry inorganic binder composition.

As indicated above, the water-dispersible water repellent as defined above is preferably added dried in the form of a water-redispersible powder.

The water-dispersible water repellent may also be premixed in a sufficient amount with a water-insoluble film-forming polymer composition in the form of an aqueous dispersion (latex) or in the form of a redispersible latex powder, before being added to the inorganic binder composition.

The binder composition thus comprises, in addition to the water-dispersible water repellent of the invention, at least one water-insoluble film-forming polymer.

The amounts of water-dispersible water repellent introduced into the water-insoluble film-forming polymer compositions are the same as those indicated above.

The redispersible latex powder to which water-dispersible water repellent has been added, that is used, may be of very varied nature.

Particular preference is given to a latex composition in the form of a redispersible powder, comprising:
at least one water-insoluble polymer,
from 0% to 35% by weight, relative to the total weight of the polymer, of at least one protective colloid,
from 0% to 30% by weight, relative to the total weight of the polymer, of anti-caking agents, and
from 0.02% to 25% by weight, relative to the total weight of the polymer, of the water-dispersible water repellent.

The redispersible latex powder to which water-dispersible water repellent has been added may be prepared by spray-drying the aqueous dispersion of polymer. This drying is carried out in conventional spray-drying systems using atomization by means of single, double or multiple liquid nozzles or of a rotary disk. The product outlet temperature chosen is generally in the range of from 50 to 100° C., preferably from 60 to 90° C., depending on the system, the glass transition temperature of the latex and the desired degree of drying.

In order to increase the storage stability and the flow capacity of the redispersible latex powder, it is preferable to introduce an anti-caking agent into the spray tower together with the aqueous dispersion of polymer, which results in a preferable deposition of the anti-caking agent on the particles of the dispersion.

The inorganic binder composition thus obtained exhibits, after consolidation, good water repellency properties and a decrease in water uptake by capillary action.

Besides the inorganic constituents, the inorganic binder compositions can also comprise organic additives, for example hydrocolloids such as cellulose ethers or guars, plasticizers, water repellents such as those mentioned above in the water-insoluble film-forming polymer compositions, inorganic or organic fibers such as fibers of polypropylene, polyethylene, polyamide, cellulose or crosslinked polyvinyl alcohol type, or a mixture thereof.

The inorganic binder composition may also comprise inorganic or organic colorants. This is in particular the case when this inorganic binder composition is used as a finishing coat.

The inorganic binder compositions may also comprise any of the additives normally used in inorganic binder compositions.

A subject of the invention is also a method for increasing the water-repellency properties of an inorganic binder composition, characterized in that a sufficient amount of at least one water-soluble water repellent is added to said composition.

Other advantages of the compositions or methods of the invention are indicated in the examples below, which are given by way of nonlimiting illustration.

The proportions and percentages indicated in the examples are by weight unless otherwise indicated.

The particle sizes are measured by means of a Horiba laser diffraction particle sizer.

### EXAMPLES

### Water Repellent Systems

The following silicone fluids were subjected to the formulating according to the invention
Silicone (A) PDMS with a carboxylated chain end, supplied by the company Rhodia.
Silicone (B): polydimethylsiloxane having a viscosity of 300 mPa.s, supplied by the company Rhodia.
Fluid resin (C): polyorganosiloxane having a formula consisting of 15% by weight of (CH₃)₃SiO_{1/2} units, 60% by weight of (CH₃)SiO_{3/2} units and 25% by weight of (CH₃)₂SiO_{2/2} units, supplied by the company Rhodia.

### 1—Example of Preparation of a Dried Emulsion of Silicone Oil A

1680 g of silicone oil A are dispersed, with stirring, in 5640 g of solution of the EGPM water-soluble amphiphilic copolymer (Rhodia), at 25% of dry extract, the initial pH of which (11.2) is gradually decreased by adding small amounts of dilute hydrochloric acid, until the desired emulsion size is reached (measurement carried out by means of a Horiba laser particle sizer on a sample of the medium).

At pH 7.5, corresponding to a viscosity of 5500 mPa/s of the continuous phase, the average diameter of the emulsion obtained is approximately 0.3 microns, by virtue of stirring at 600 rpm maintained for 25 minutes.

The emulsion thus obtained is then slightly diluted with deionized water so that its viscosity falls to 400 mPa/s, and is then sprayed in a Niro Minor atomizer supplied with hot air. The air inlet temperature is from 140 to 160° C. and the air outlet temperature is between 80 and 100° C.

A dry powder that can be handled and the average diameter of which is in the region of 80 microns is thus obtained.

In order to be sure of the quality of this dried powder, 1 g thereof is removed and is dispersed with gentle stirring in 50 g of distilled water, and the particle size of the dispersion thus reconstituted is measured. It is noted that this process makes it possible to regenerate a silicone oil emulsion, the particle size of which is of the same order of magnitude as that of the concentrated emulsion of origin (1 micron or less). A powder that is a dried emulsion, and that can be redispersed in water at the size of the emulsion of origin, was therefore clearly obtained.

### 2—Examples Illustrating the Effective Redispersion of the Dried Emulsions in an Aqueous Phase

Comparative trials between the following products:

Invention 1: Dry emulsion of silicone oil (A)

Invention 2: Dry emulsion of silicone oil (B)

Invention 3: Dry emulsion of silicone resin (C)

Comparative 1: Silicone oil (B) absorbed onto Tixosil 38X® silica

Comparative 2: Sodium laurate

Comparative 3: Calcium stearate

Comparative 4: Silanes adsorbed onto Wacker PC-A precipitated silica

Comparative 5: Silanes adsorbed onto Wacker PC-B precipitated silica

It should be noted that the sodium laurate becomes a water repellent in situ on contact with the calcium in the cement phase; in the sodium laurate state it is not water repellent.

These products, which are all in the form of a fine powder, are added in a proportion of 2 g in 100 cc of deionized water. The water is placed in a 250 cc beaker and the 2 g of powders to be compared are added at the surface of the water without stirring. Their behavior is then observed, and these observations are summarized in table I below:

TABLE 1

| Products | Wetting | Appearance of | Dispersion |
|---|---|---|---|
| compared | rate | the solution | particle size |
| Dry emulsion of | Immediate | Turbid | 0.8 micron |
| silicone oil | | | and |
| (A) (invention) | | | 10 microns |
| Dry emulsion of | Immediate | Turbid | Approx. |
| silicone oil | | | 1 micron |
| (B) (invention) | | | |
| Dry emulsion of | Immediate | Turbid | Approx. |
| silicone resin | | | 1 micron |
| (C) (invention) | | | |
| Silicone oil | Remains at | Slightly | Silica in |
| (B) absorbed | the surface | cloudy | suspension |
| onto Tixosil | | | |
| 38X silica | | | |
| (50/50) | | | |
| (comparative 1) | | | |
| Calcium | Remains at | Clear | No dispersion |
| stearate | the surface | | |
| (comparative 2) | | | |
| Sodium laurate | Dissolves | Slightly | Soap colloids |
| (comparative 3) | slowly | turbid | |
| Wacker PC-A | Remains at | Clear | No dispersion |
| (comparative 4) | the surface | | |
| Wacker PC-B | Remains at | Clear | No dispersion |
| (comparative 5) | the surface | | |

The excellent wetting capacity and dispersing capacity of the forms according to the invention is noted, whereas the conventional forms or forms from competitors do not disperse spontaneously in water, which gives a clear explanation as to the difficulties encountered when mixing cement formulations that contain these conventional forms.

### 3—Examples Illustrating the Water-Repellent Effects on Finished Materials (Cement Materials)

This evaluation is carried out on cement test samples obtained by mixing and then by setting of the following composition:

| | | |
|---|---|---|
| Portland R52-5 cement | 150 | g |
| Sand with a fine particle size | 15 | g |
| Water repellent (as active agent) | 0.3 | g |
| Water | 75 | g |

This composition is placed in a mold for generating test samples of 100×30×6 mm.

After setting, the test samples are removed from the mold and aged for 28 days under ambient temperature and relative humidity conditions.

In order to judge the water-repellent effect on the material obtained, a series of tests is carried out so as to determine the behavior of the material at various levels.

The following are in particular observed:
the “pearling” effect on all faces of the test sample. The pearling effect is evaluated by depositing a drop of water on the surface to be characterized, measuring the initial contact angle by means of an optical method and, where appropriate, observing the rate of penetration of the drop of water into the material. The penetration time, if the cement material is highly hydrophobic, may be several hours;
the water-repellent effect with respect to liquid water (height, in mm, of the rise due to capillary action in the cement test sample and weight uptake), the test samples being placed on a film of water that wets only the bottom of the test sample up to a height of 5 mm;
water vapor uptake expressed as weight gain after a period of time spent in a moist atmosphere for 72 h (90% RH and 25° C.);
finally, a measurement of flexural strength of the test samples is carried out on a tensile testing device (Zwieck brand) in order to judge the effect of the water repellent on the mechanical properties of the material obtained.

The results are given in table II.

TABLE II

| | | | Water vapor | |
|---|---|---|---|---|
| | Pearling | | barrier | |
| | effect | Water | Weight up- | |
| | (deposition | rise due | take in a | Mechanical |
| | of a drop of | to | moist | properties |
| Products | water on the | capillary | atmosphere | Strength |
| compared | surface) | action | 90% RH | in mPa · s |
| Cement test | NO | 62 mm | 12% | 13 |
| sample with no | | | | |
| additive (control) | | | | |
| Dry emulsion of | Yes, | 5 mm | 14% | 18 |
| silicone (A) | lasting | | | |
| (invention) | effect on | | | |
| | all faces | | | |
| Dry emulsion of | Yes, | 8 mm | 14% | — |
| silicone (B) | lasting | | | |
| (invention) | effect on | | | |
| | all faces | | | |
| Dry emulsion of | Yes, | 10 mm | 13% | — |
| silicone resin | lasting | | | |
| (C) (invention) | effect on | | | |
| | all faces | | | |
| Silicone oil (B) | No | 22 mm | 12% | 10 |
| absorbed onto | | | | |
| Tixosil 38X | | | | |
| silica | | | | |
| (comparative 1) | | | | |
| Sodium laurate | Yes, weak | 31 mm | 9% | 6 |
| (water repellent | | | | |
| in the calcium | | | | |
| laurate state) | | | | |
| (comparative 2) | | | | |
| Wacker PC-A | Yes, weak | 10 mm | 12% | 5 |
| powder | | | | |
| (comparative 4) | | | | |
| Wacker PC-B | No | 30 mm | — | — |
| powder | | | | |
| (comparative 5) | | | | |

It is noted that the products according to the invention are superior to the other products with respect to all the examination criteria, in particular with respect to the fact that the “pearling” effect is observed on all the faces of the test samples and including, moreover, in the mass (trials carried out, after breaking of the test samples for the mechanical test, on the broken piece).

In addition, there is little impact by the water-dispersible water repellents according to the invention on the mechanical properties, or there is even a positive effect observed for the case of the dry emulsion of silicone oil (A).

It is also noted that the dry emulsion form of water-dispersible water repellent gives higher performance levels than the same initial water-insoluble and/or water-immiscible water repellent that is absorbed onto an inorganic support, in particular onto a support consisting of Tixosil 38X® precipitated silica. It is sufficient to compare the performance levels of the dry emulsion of silicone (B) with comparative example 1.

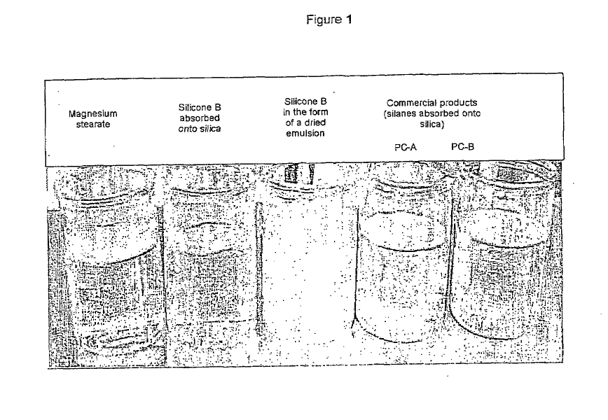

The photograph of FIG. 1 illustrates the behavior in water of various forms of powders having a water-repellent nature. It corresponds to a contact time of 10 min after the powder has been deposited at the surface of the water, without agitation.

It is noted that most of the water repellents disperse poorly or not at all in the water (magnesium stearate, silicone deposited on a silica support, Wacker PC-A and PC-B comparative products).

The sodium laurate disperses and dissolves partially, but, in its sodium laurate form, it is not a good water repellent. It becomes so in situ in a cement or plaster suspension due to conversion into salts of calcium, which is itself insoluble and floats at the surface of the aqueous solution.

On the other hand, the dry silicone emulsion form of the invention rapidly gives a calibrated dispersion of the water repellent throughout the homogeneous and stable suspension.

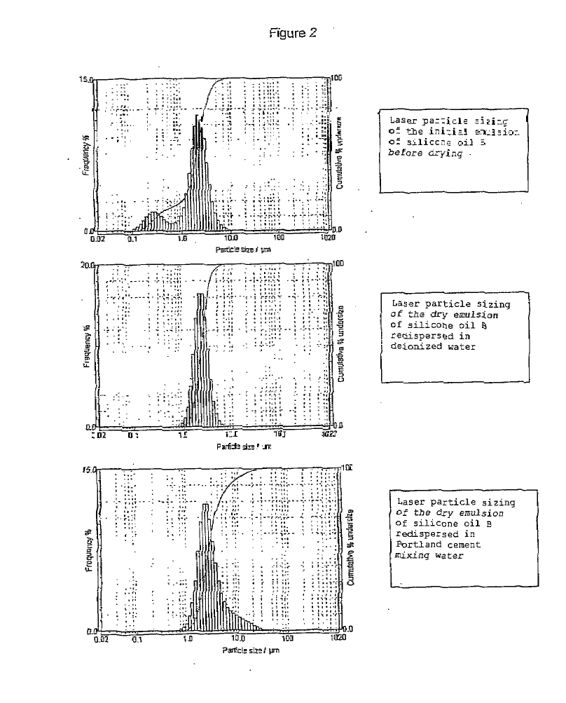

This point is also confirmed by the measurements of the particle size of the redispersions given in FIG. 2, which show that the size of the redispersion remains the same regardless of the medium into which it is introduced.

In particular, the soluble salts present in the mixing water of a Portland type cement do not bring about any flocculation or modification of the redispersion of silicones.

1-26. (canceled)

27. A water-dispersible water repellent based on at least one water-insoluble and water-immiscible water repellent that has previously been emulsified in a water-soluble amphiphilic copolymer composition.

28. The water-dispersible water repellent as claimed in claim 27, wherein the water-soluble amphiphilic copolymer is:
(i) at least one polymer obtained by polymerization
of at least one ethylenically unsaturated monomer (I) of monocarboxylic or polycarboxylic acid, or else anhydride-type carboxylic acid precursor that is aliphatic, cyclic, linear or branched, and
of at least one linear or branched, monoethylenically unsaturated hydrocarbon-based monomer (II);
(ii) at least one polymer derived from the polymerization of at least one ethylenically unsaturated, aliphatic, cyclic, linear or branched, monocarboxylic or polycarboxylic acid, or anhydride, monomer (I), and having at least one saturated or unsaturated C₄-C₃₀ hydrocarbon-based hydrophobic graft, optionally interrupted with one or more heteroatoms; or
(iii) at least one polymer obtained by chemical modification, of a precursor polymer comprising, firstly, sites onto which it is possible to graft a hydrophobic graft, and having carboxylic acid or carboxylic acid precursor units.

29. The water-dispersible water repellent as claimed in claim 27, wherein the water-soluble arnphiphilic copolymer is:
(i) at least one polymer obtained by polymerization
of at least one ethylenically unsaturated monomer (I) of monocarboxylic or polycarboxylic acid, or else anhydride-type carboxylic acid precursor, that is aliphatic, cyclic, linear or branched, and
of at least one linear or branched, monoethylenically unsaturated hydrocarbon-based monomer (II), this hydrocarbon-based monomer not being aromatic;
(ii) at least one polymer derived from the polymerization of at least one ethylenically unsaturated, aliphatic, cyclic, linear or branched, monocarboxylic or polycarboxylic acid, or anhydride, monomer (I), and having at least one saturated or unsaturated C₄-C₃₀ hydrocarbon-based hydrophobic graft, optionally interrupted with one or more heteroatoms, this hydrophobic graft not being aromatic; or
(iii) at least one polymer obtained by chemical modification, of a precursor polymer comprising, firstly, sites onto which it is possible to graft a hydrophobic graft, this hydrophobic graft not being aromatic, and having, secondly, carboxylic acid or carboxylic acid precursor units.

30. The water-dispersible water repellent as claimed in claim 27, wherein the water-insoluble and/or water-immiscible water repellent is:
silicones; or
water repellents other than water-insoluble and/or water-immiscible silicones, which are:
fatty acids, fatty acid carboxylates having a divalent counterion fatty acid esters,;
paraffins of formula CₙH₂ₙ₊₂ with n between 6 and 22 carbon atoms,
CₙH₂ₙ olefins with n between 6 and 22 carbon atoms, that are fluid or liquid at ambient temperature; and
waxes.

31. The water-dispersible water repellent as claimed in claim 27, wherein the water-insoluble and/or water-immiscible water repellent comprises at least one silicone.

32. The water-dispersible water repellent as claimed in claim 31, wherein the silicone is fluid.

33. The water-dispersible water repellent as claimed in claim 27, exhibiting proportions of the water-insoluble and/or water-immiscible water repellent and of the water-soluble amphiphilic copolymer of between:
70% and 30% by dry weight of the water-insoluble and/or water-immiscible water repellent relative to the total weight of the dry mixture; and
30% and 70% by dry weight of the water-soluble amphiphilic copolymer relative to the total weight of the dry mixture.

34. The water-dispersible water repellent as claimed in claim 27, wherein it is in the form of a water-redispersible powder.

35. A water-insoluble film-forming polymer composition comprising a water-dispersible water repellent as claimed in claim 27.

36. The composition as claimed in claim 35, wherein the composition is in the form of an aqueous dispersion of water-insoluble film-forming polymer (latex).

37. The composition as claimed in claim 35, wherein the composition is in the form of a redispersible latex powder.

38. The composition as claimed in claim 35, having an amount of water-dispersible water repellent of between 10% and 90% by weight of dry water-soluble water repellent relative to the total weight of the dry mixture, and
an amount of the aqueous dispersion of water-insoluble film-forming polymer (latex) of between 90% and 10% by weight of dry latex relative to the total weight of the dry mixture.

39. The composition as claimed in claim 38, wherein:
the amount of water-dispersible water repellent is between 40% and 60% by weight of dry water-soluble water repellent relative to the total weight of the dry mixture, and
the amount of the aqueous dispersion of water-insoluble film-forming polymer (latex) is between 60% and 40% by weight of dry latex relative to the total weight of the dry mixture.

40. The composition as claimed in claim 35, wherein the water-insoluble film-forming polymer is obtained by polymerization of monomers which are vinyl esters or
vinylaromatic monomers.

41. The composition as claimed in claim 40, wherein the monomers are further copolymerized with other ethylenically unsaturated monomers.

42. The composition as claimed in claim 35, further comprising another solid water repellent, which is a fatty acid in free acid form or in the form of an alkali metal salt thereof.

42. An inorganic binder composition comprising a water-soluble water repellent as claimed in claim 27.

43. The composition as claimed in claim 42, wherein the inorganic binder is an air-setting binder chosen from plasters.

44. The composition as claimed in claim 42, wherein the inorganic binder is a hydraulic binder chosen from cements, fly ash, calcined shales or pozzolans.

45. The composition as claimed in claim 42, having an amount of water-soluble water repellent of between 0.05% and 10% by dry weight of water-soluble water repellent relative to the total weight of the composition of dry inorganic binder.

46. The composition as claimed in claim 45, wherein the amount of water-dispersible water repellent is between 0.1% and 5% by dry weight of the water-soluble water repellent relative to the total weight of the dry binder composition.

47. The composition as claimed in claim 42, wherein it also comprises a water-insoluble film-forming polymer.

48. A method of preparing an inorganic binder composition as claimed in claim 35, wherein the water-dispersible water repellent is premixed with a water-insoluble film-forming polymer composition in the form of an aqueous dispersion (latex) or in the form of a redispersible latex powder.

49. A method for increasing the water-repellency properties of an inorganic binder composition, comprising the step of adding a water-repellent efficient amount of at least one water-dispersible water repellent as claimed in claim 27, to said composition.
